(19) United States
(12) Patent Application Publication
(10) Pub. No.: US 2022/0309938 A1
(43) Pub. Date: Sep. 29, 2022

(54) ONLINE VIDEO DISTRIBUTION SUPPORT METHOD AND ONLINE VIDEO DISTRIBUTION SUPPORT APPARATUS

(71) Applicant: PANASONIC INTELLECTUAL PROPERTY MANAGEMENT CO., LTD., Osaka (JP)

(72) Inventors: Takeshi YOSHIHARA, Fukuoka (JP); Koji HORIUCHI, Fukuoka (JP)

(73) Assignee: PANASONIC INTELLECTUAL PROPERTY MANAGEMENT CO., LTD., Osaka (JP)

(21) Appl. No.: 17/704,204

(22) Filed: Mar. 25, 2022

(30) Foreign Application Priority Data
Mar. 29, 2021 (JP) 2021-055469

(51) Int. Cl. G09B 5/14; G09B 5/06; G06F 3/01; H04N 7/14

(52) U.S. Cl. CPC G09B 5/14; G09B 5/067; G06F 3/013; H04N 7/142

(57) ABSTRACT

An online video distribution support method is performed by a system including one or more computers connected to communicate with viewer terminals. The method includes: acquiring a viewer image from each of the viewer terminals; displaying a screen including viewer images; detecting, using a captured image of a distributor, a line-of-sight direction of the distributor; determining, based on the line-of-sight direction, a viewer corresponding to a viewer image on the screen toward which a line-of-sight of the distributor is directed, and determining priorities of the viewer images to be displayed on the screen; and generating an updated screen using the priorities to switch the viewer images on the screen, and displaying the updated screen.

### CROSS-REFERENCE TO RELATED APPLICATIONS

This application is based on and claims the benefit of priority of Japanese Patent Application No. 2021-055469 filed on Mar. 29, 2021, the entire contents of which are incorporated herein by reference.

### FIELD

The present disclosure relates to an online video distribution support method and an online video distribution support apparatus.

### BACKGROUND

JP-A-2016-114684 discloses an understanding level estimation device that estimates, based on a line-of-sight movement direction of the participant participating in a lecture content calculated by line-of-sight information of the participant and a slide direction of a slide before and after slide switching of the lecture content, an understanding level of the participant with respect to the slide. The understanding level estimation device acquires the line-of-sight information of the participant participating in the lecture content, records the line-of-sight information in a recording unit, and calculates the line-of-sight movement direction before and after switching of the slide using a line-of-sight coordinate included in the line-of-sight information and a measurement time of the line-of-sight coordinate, and a switching time when the slide of the lecture content is slid and switched. The understanding level estimation device determines, based on a calculated cosine value of an angle formed by the slide direction and the line-of-sight movement direction before the switching of the slide and a calculated cosine value of an angle formed by the slide direction and the line-of-sight movement direction after the switching of the slide, the understanding level of the participant with respect to the slide.

### SUMMARY

Here, a lecturer who gives an online lecture using the lecture content has a desire to visually confirm states of all participants during the lecture and find the participant who has a low understanding level of the lecture and needs to follow in understanding the lecture. However, in the online lecture in which a large number of participants using a video call system can participate, it is difficult for the lecturer to remember which one of a large number of participants displayed on a monitor provided on a lecturer side is looking at the lecture while giving the lecture. In such an online lecture, when a gallery view of all the participants cannot be displayed on the monitor at the same time, it is necessary to switch and display the gallery view of the participants for each predetermined number of people. Therefore, the lecturer has to remember who is the participant that is not looking at the lecturer while giving the lecture, and it is difficult to efficiently look at the participant who is not looking at the lecture.

The present disclosure is made in view of the above circumstances in the related art, an object of the present disclosure is to provide an online video distribution support method and an online video distribution support apparatus that more effectively display a gallery view of viewers who view online video distribution and efficiently support visual confirmation of a state of a viewer by a distributor.

The present disclosure provides an online video distribution support method performed by a system including one or more computers that are connected to communicate with a plurality of viewer terminals used by N (N being an integer equal to or larger than 3) viewers, respectively, who view online video distribution, the online video distribution support method including: acquiring a viewer image from each of the viewer terminals, the viewer image being obtained by capturing each of the viewers; displaying a screen including viewer images obtained by capturing images of M (M being an integer equal to or larger than 2 and M≤N) viewers, respectively; detecting, using a captured image obtained by capturing an image of a distributor who performs the online video distribution, a line-of-sight direction of the distributor; determining, based on the line-of-sight direction, a viewer corresponding to a viewer image on the screen toward which a line-of-sight of the distributor is directed, and determining priorities of the viewer images to be displayed on the screen; and generating an updated screen using the priorities to switch the viewer images on the screen, and displaying the updated screen.

The present disclosure provides an online video distribution support apparatus including one or more computers, the online video distribution support apparatus including: an acquisition unit configured to acquire a viewer image of each of N (N being an integer equal to or larger than 3) viewers who views online video distribution; an output unit configured to output a screen including viewer images obtained by capturing images of M (M being an integer equal to or larger than 2 and M≤N) viewers; a detection unit configured to detect, using a captured image obtained by capturing an image of a distributor who performs the online video distribution, a line-of-sight direction of the distributor; and a control unit configured to: determine, based on the line-of-sight direction, a viewer corresponding to a viewer image on the screen toward which a line-of-sight of the distributor is directed, and determine priorities of the viewer images to be displayed on the screen; generate an updated screen using the priorities to switch the viewer images on the screen, and output the updated screen to the output unit.

According to the present disclosure, it is possible to more effectively display a gallery view of the viewers who view the online video distribution, and to efficiently support visual confirmation of a state of the viewer by the distributor.

### BRIEF DESCRIPTION OF DRAWINGS

FIG. 1 is a block diagram showing an example of an internal configuration of an online video distribution support system according to a first embodiment.

FIG. 2 is a diagram showing an example of a use case of a distributor terminal and an example of a video distribution screen.

FIG. 3 is a flowchart showing an example of an operation procedure of the distributor terminal according to the first embodiment.

FIG. 4 is a flowchart showing an example of a line-of-sight detection procedure of the distributor terminal according to the first embodiment.

FIG. 5 is a diagram showing an example of a display order table according to the first embodiment.

FIG. 6 is a diagram showing an example of the display order table according to the first embodiment.

FIG. 7 is a diagram showing an example of display switching of a viewer image according to the first embodiment.

FIG. 8 is a diagram showing another example of the video distribution screen.

FIG. 9 is a block diagram showing an example of an internal configuration of an online video distribution support system according to a modification of the first embodiment.

FIG. 10 is a flowchart showing an example of the operation procedure of the distributor terminal according to a second embodiment.

FIG. 11 is a diagram showing an example of the display order table according to the second embodiment.

FIG. 12 is a diagram showing an example of the display order table according to the second embodiment.

### DETAILED DESCRIPTION

Hereinafter, embodiments specifically disclosing configurations and operations of an online video distribution support method and an online video distribution support apparatus according to the present disclosure will be described in detail with reference to the drawings as appropriate. Unnecessarily detailed description may be omitted. For example, the detailed description of a well-known matter or repeated description of substantially the same configuration may be omitted. This is to avoid unnecessary redundancy in the following description and to facilitate understanding for those skilled in the art. The accompanying drawings and the following description are provided for those skilled in the art to fully understand the present disclosure, and are not intended to limit the subject matter described in the claims.

### First Embodiment

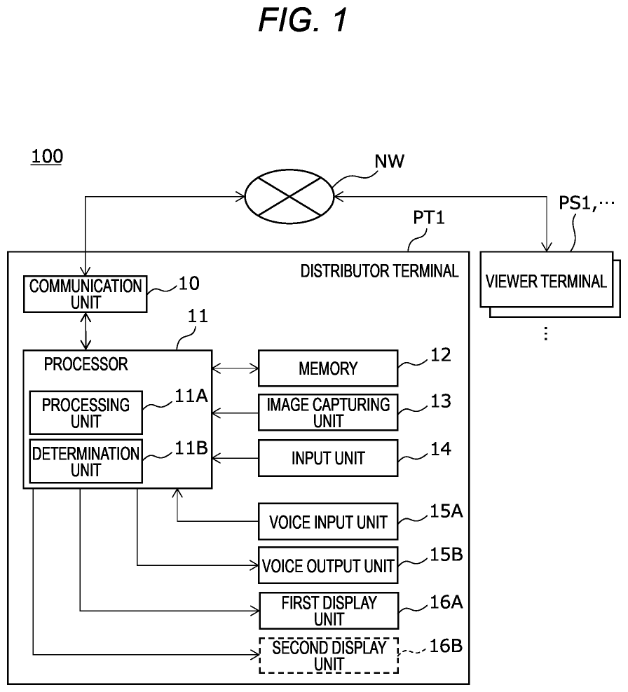

First, an internal configuration of an online video distribution support system 100 according to the first embodiment will be described with reference to FIG. 1. FIG. 1 is a block diagram showing an example of the internal configuration of the online video distribution support system 100 according to the first embodiment. The online video distribution support system 100 shown in FIG. 1 is an example, and the present invention is not limited thereto.

A distributor terminal PT1 as an example of an online video distribution support apparatus is operated by a distributor TC that performs online video distribution, and is implemented by, for example, a personal computer (PC), a notebook PC, a tablet terminal, and a smartphone. The distributor terminal PT1 is connected via network NW to viewer terminals PS1 and so on used by one or more viewers who view the online video distribution so as to be able to perform wireless communication with the viewer terminals PS1 and so on. The wireless communication here is communication via a wireless local area network (LAN) such as Wi-Fi (registered trademark).

The distributor terminal PT1 switches an image (live video) of a viewer (hereinafter referred to as a “viewer image”) displayed on a first display unit 16A or a second display unit 16B in order to enable the distributor TC to visually confirm a state of each of a plurality of viewers who view the online video distribution (for example, a state of whether the viewer understands a distribution content of the online video distribution). The distributor terminal PT1 includes a communication unit 10, a processor 11, a memory 12, an image capturing unit 13, an input unit 14, a voice input unit 15A, a voice output unit 15B, and the first display unit 16A. The second display unit 16B is not an essential component, and may be omitted. Although not shown in FIG. 1, the distributor terminal PT1 may include three or more display units.

The communication unit 10 transmits and receives, via the network NW, data to and from the viewer terminals PS1 and so on used by the viewers. The communication unit 10 outputs the viewer image (live video) transmitted from the viewer terminals PS1 and so on to the processor 11. The communication unit 10 transmits, based on an operation by the distributor TC received by the input unit 14, data of a shared material displayed on a monitor, a display, or the like (not shown) included in the viewer terminals PS1 and so on used by the viewers.

The processor 11 is configured using, for example, a central processing unit (CPU) or a field programmable gate array (FPGA), and performs various processing and control in cooperation with the memory 12. Specifically, the processor 11 refers to a program and data held in the memory 12 and executes the program to implement functions of each unit. The unit mentioned here are, for example, a processing unit 11A, a determination unit 11B, and the like.

The processing unit 11A executes a convolutional neural network (CNN) analysis processing on a captured image output from the image capturing unit 13, and estimates a position toward which a line-of-sight of the distributor TC is directed (hereinafter referred to as a “line-of-sight position”). The processing unit 11A outputs information on the line-of-sight position of the distributor TC, which is an estimation result, to the determination unit 11B. A known technique other than the CNN analysis processing may be used for a processing of estimating the line-of-sight position.

The determination unit 11B determines, based on the information on the line-of-sight position of the distributor TC output from the processing unit 11A, whether the distributor TC is viewing a region in which the shared material in a video distribution screen is displayed (hereinafter referred to as a “shared material display region”) or a region in which the viewer image is displayed (hereinafter referred to as a “viewer image display region”). When it is determined that the line-of-sight position of the distributor TC is positioned in the viewer image display region, based on the line-of-sight position, the determination unit 11B determines which viewer image in the viewer image display region is viewed (that is, which part of the viewer image display region the line-of-sight of the distributor TC is positioned in), and identifies the viewer corresponding to the viewer image toward which the distributor TC directs the line-of-sight.

Further, the determination unit 11B determines whether the line-of-sight of the distributor TC deviates from the viewer image of an identified viewer. When it is determined that the line-of-sight position of the distributor TC deviates from the viewer image of the identified viewer, the determination unit 11B measures a time when the line-of-sight of the distributor TC deviates from the viewer image by the line-of-sight of the distributor TC as a gaze time when the distributor TC gazes at the viewer corresponding to the viewer image, outputs a measured gaze time or an elapsed time that elapses from the gaze time and identification information that can identify the viewer in association with each other to the memory 12, and updates a display order table recorded in the memory 12.

In addition, based on the gaze time and the identification information of the viewer, the determination unit 11B updates elapsed times of all viewers recorded in the display order table and next priorities (hereinafter referred to as a “display order”) of viewer images of the viewers included in the video distribution screen displayed on the first display unit 16A or the second display unit 16B. In an example shown in the first embodiment, an example in which the elapsed time and the display order are recorded in the display order table will be described, but the gaze time and the display order may be recorded. In addition, update of the elapsed times and the display order of all the viewers recorded in the display order table may be executed at a frequency corresponding to a frame rate of the image capturing unit 13 of the distributor terminal PT1.

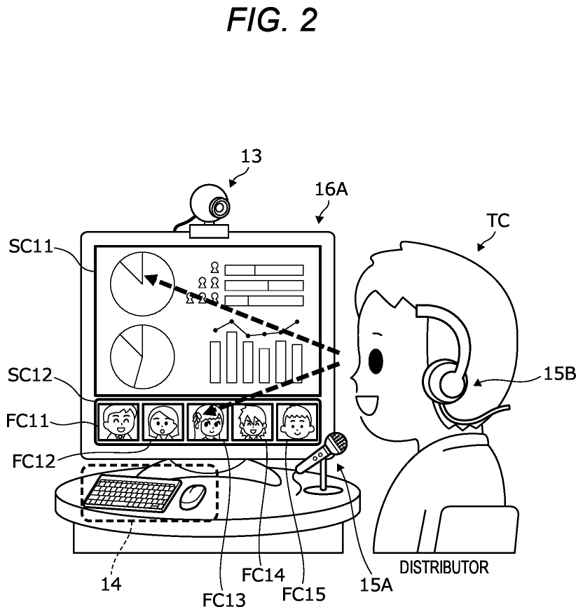

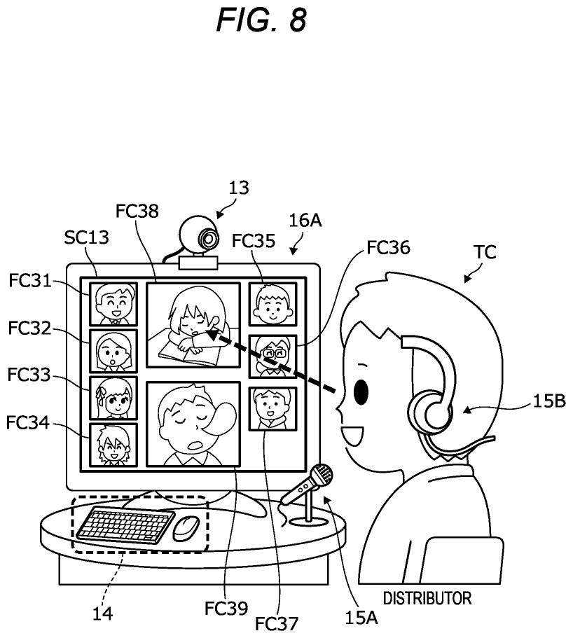

In addition, the determination unit 11B determines whether a slide of the shared material used for the online video distribution is switched by the distributor TC. When it is determined that the slide of the shared material is switched by the distributor TC or a predetermined time (for example, 3 minutes, 5 minutes, 10 minutes, or the like) elapses, the determination unit 11B determines, based on the display order table recorded in the memory 12, the display order of the viewer images of the viewer displayed on the first display unit 16A or the second display unit 16B. The determination unit 11B generates the video distribution screen (see FIGS. 2 and 8) including the viewer image of the viewer based on the determined display order of the viewers, outputs the video distribution screen to the first display unit 16A or the second display unit 16B and causes the first display unit 16A or the second display unit 16B to display the video distribution screen.

Here, a method of determining the display order performed by the determination unit 11B in the first embodiment will be described. The determination unit 11B sets the elapsed time of the viewer having no elapsed time recorded in the display order table (that is, the viewer who has never been viewed by the distributor TC) to an elapsed time from a start time of the online video distribution, and rearranges the viewers in descending order of the elapsed time.

The determination unit 11B determines an order of the viewers after the rearrangement as the display order of the viewers. The determination unit 11B generates, based on the determined display order, the video distribution screen including viewer images of a predetermined number of viewers (for example, any number of people such as 5, 8 or 10) from a top of the display order, and outputs the video distribution screen to the first display unit 16A or the second display unit 16B and causes the first display unit 16A or the second display unit 16B to display the video distribution screen.

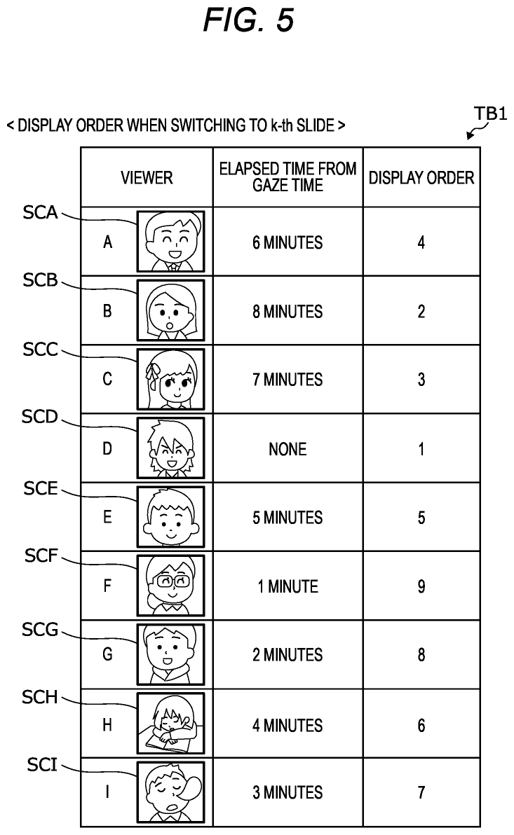

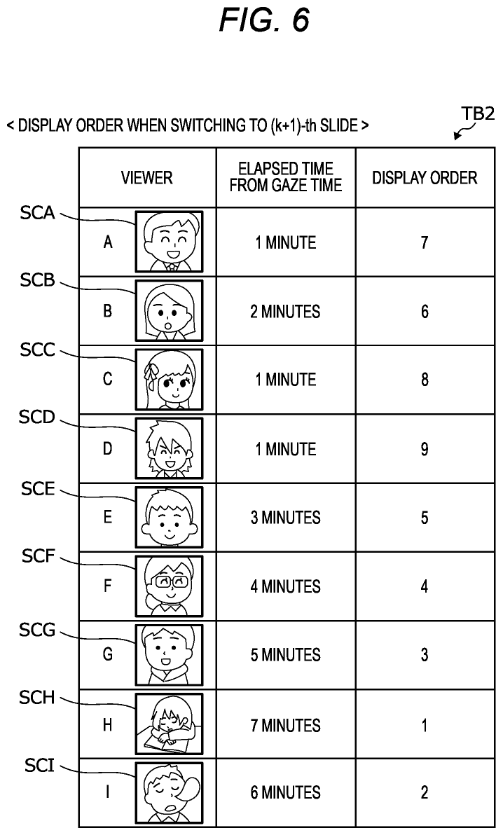

When it is determined that the shared material displayed on the first display unit 16A is not switched for a predetermined time (for example, 3 minutes, 5 minutes, 10 minutes, or the like) or more set in advance, the determination unit 11B may determine the display order of all the viewers based on the display order table (see FIGS. 5 and 6) recorded in the memory 12 at a timing when the predetermined time elapses, generate the video distribution screen including the viewer images of a predetermined number of viewers (for example, any number of people such as 5, 8 or 10) from the top of the display order, output the video distribution screen to the first display unit 16A or the second display unit 16B and cause the first display unit 16A or the second display unit 16B to display the video distribution screen.

Further, when an operation for switching the display order or display of the viewer image displayed on the video distribution screen by the distributor TC is received by the input unit 14, the determination unit 11B may determine the display order of all the viewers based on the display order table recorded in the memory 12 at a timing when the operation is received, generate the video distribution screen including the viewer images of a predetermined number of viewers from the top of the display order, and output the video distribution screen to the first display unit 16A or the second display unit 16B and cause the first display unit 16A or the second display unit 16B to display the video distribution screen.

The memory 12 includes a recording device including a semiconductor memory such as a random access memory (RAM) and a read only memory (ROM) and any one of storage devices such as a solid state drive (SSD) or a hard disk drive (HDD). The memory 12 records identification information that can identify all the viewers who view the online video distribution, the display order table, and the like. The memory 12 stores a learning model used in the CNN analysis processing.

The image capturing unit 13 includes, for example, a solid-state imaging device of a charged-coupled device (CCD) or a complementary metal oxide semiconductor (CMOS), and converts an optical image formed on an imaging surface into an electric signal. The image capturing unit 13 outputs the captured image obtained by capturing an image of the distributor TC to the processing unit 11A in the processor 11.

The input unit 14 is a user interface configured using, for example, a touch panel, a keyboard, a mouse, or the like. The input unit 14 converts a received distributor TC operation into an electric signal (control command) and outputs the electric signal to the processor 11. When the input unit 14 is configured using the touch panel, the input unit 14 may be configured integrally with the first display unit 16A or the second display unit 16B.

The voice input unit 15A is configured with a microphone or the like, converts collected voice (sound) of the distributor TC into an electric signal, and outputs the electric signal to the processor 11. The electric signal output to the processor 11 is transmitted from the communication unit 10 to the viewer terminals PS1 and so on via the network NW, and is output from a speaker (not shown) included in the viewer terminals PS1 and so on.

The voice output unit 15B is configured with, for example, a speaker, an earphone, and a headphone, and converts an electric signal based on voice (sound) of the viewer transmitted from each of the viewer terminals PS1 and so on into voice (sound) and outputs the voice (sound).

The first display unit 16A and the second display unit 16B are configured using, for example, a display such as a liquid crystal display (LCD) or an organic electroluminescence (EL). The first display unit 16A and the second display unit 16B display the video distribution screen (see FIGS. 2 and 8) output from the processor 11. The number of display units included in the distributor terminal PT1 may be at least one, and specifically, may be only the first display unit 16A.

The network NW connects the distributor terminal PT1 and a plurality of viewer terminals PS1 and so on so that the distributor terminal PT1 and the plurality of viewer terminals PS1 and so on can perform wireless communication.

Each of the plurality of viewer terminals PS1 and so on is operated by the viewer who views the online video distribution, and is implemented by, for example, a PC, a notebook PC, a tablet terminal, a smartphone, or the like. Each of the plurality of viewer terminals PS1 and so on is connected to the distributor terminal PT1 via the network NW so as to be able to perform wireless communication with the distributor terminal PT1. The wireless communication here is communication via a wireless LAN such as Wi-Fi (registered trademark). Each of the plurality of viewer terminals PS1 and so on includes a camera (not shown) capable of capturing an image of the viewer, and transmits the captured viewer image (live video) to the distributor terminal PT1. Each of the plurality of viewer terminals PS1 and so on displays the video distribution screen based on data of the shared material and the like transmitted from the distributor terminal PT1, or converts an electric signal into voice (sound) and outputs the voice (sound) from the speaker (not shown).

Next, the video distribution screen displayed on the first display unit 16A of the distributor terminal PT1 will be described with reference to FIG. 2. FIG. 2 is a diagram showing an example of a use case of the distributor terminal PT1 and an example of the video distribution screen.

A display layout of the video distribution screen shown in FIG. 2 is an example and the present invention is not limited thereto. Although an example is shown in which the distributor terminal PT1 in the example shown in FIG. 2 has a configuration including only the first display unit 16A, the distributor terminal PT1 may include the second display unit 16B or may include a third display unit (not shown). When the distributor terminal PT1 is configured to include the second display unit 16B or the third display unit, a shared material display region SC11 and a viewer image display region SC12 may be displayed on different display units.

The image capturing unit 13 shown in the example of the use case in FIG. 2 is installed at a position where the image capturing unit 13 can capture a face image of the distributor TC. It is needless to say that an installation position of the image capturing unit 13 is not limited to a position on the first display unit 16A as long as the image capturing unit 13 can capture the face image of the distributor TC.

The input unit 14 shown in the example of the use case in FIG. 2 is implemented by a keyboard and a mouse. The voice input unit 15A is implemented by the microphone. The voice output unit 15B is implemented by the headphone. When the voice output unit 15B is implemented by, for example, the headphone with the microphone, the voice input unit 15A may be configured integrally with the voice output unit 15B.

The first display unit 16A in the example of the use case shown in FIG. 2 displays the video distribution screen including the shared material display region SC11 and the viewer image display region SC12. In the shared material display region SC11, the shared material for the online video distribution designated by a distributor TC operation is displayed. In the viewer image display region SC12, viewer images FC11, FC12, FC13, FC14, and FC15 (live video) of five viewers determined by the determination unit 11B in the processor 11 are displayed. Each of the five viewer images FC11 to FC15 displayed in the viewer image display region SC12 is determined by the determination unit 11B every time the slide of the shared material displayed in the shared material display region SC11 on the video distribution screen is switched by the distributor TC operation, every predetermined time (for example, 3 minutes, 5 minutes, 10 minutes, or the like) set in advance, or every time an operation requesting switching of the viewer image by the distributor TC is received.

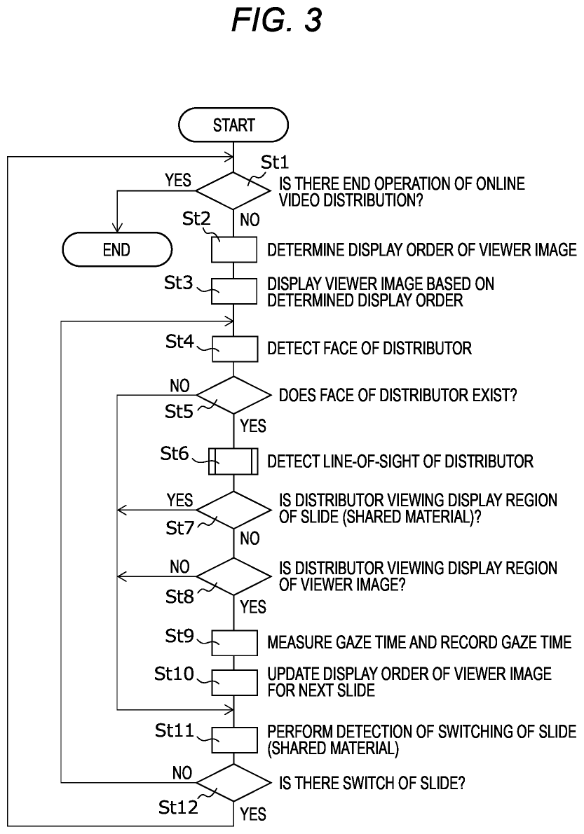

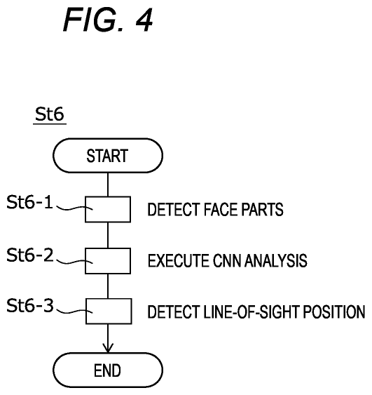

Next, an operation procedure of the distributor terminal PT1 according to the first embodiment will be described with reference to FIGS. 3 and 4. FIG. 3 is a flowchart showing an example of the operation procedure of the distributor terminal PT1 according to the first embodiment. FIG. 4 is a flowchart showing an example of a line-of-sight detection procedure of the distributor terminal PT1 according to the first embodiment.

In the examples shown in FIGS. 3 and 4, an example of switching the viewer image included in the video distribution screen based on the switching of the slide of the shared material will be described, but it is needless to say that the switching of the viewer image included in the video distribution screen may be executed every predetermined time set in advance.

The distributor terminal PT1 determines whether there is an end operation to end the online video distribution by the distributor TC (that is, whether the end operation is received by the input unit 14) (St1). When it is determined in the processing of step St1 that there is the end operation to end the online video distribution by the distributor TC (St1, YES), the distributor terminal PT1 disconnects communication with the plurality of viewer terminals PS1 and so on, and ends the online video distribution.

On the other hand, when it is determined in the processing of step St1 that there is no end operation to end the online video distribution by the distributor TC (St1, NO), the distributor terminal PT1 refers to the display order table currently recorded in the memory 12, and determines, based on the display order recorded in the display order table, the display order (priorities) of the viewers displayed on the video distribution screen (St2).

The distributor terminal PT1 generates, based on the determined display order of the viewers, the video distribution screen (see FIGS. 2 and 8) including the viewer images of a predetermined number of viewers, and causes the first display unit 16A or the second display unit 16B to display the video distribution screen (St3). The distributor terminal PT1 executes an image analysis on the captured image captured by the image capturing unit 13, detects the face of the distributor TC (St4), and determines, based on a detection result, whether the face of the distributor TC can be detected from the captured image (St5).

When it is determined in the processing of step St5 that the face of the distributor TC can be detected from the captured image (St5, YES), the distributor terminal PT1 detects the line-of-sight of the distributor TC (St6). Specifically, the distributor terminal PT1 detects face parts of the distributor TC from the captured image (St6-1). The distributor terminal PT1 executes a CNN analysis on a region including both eyes of the distributor TC in the detected face parts (St6-2). The distributor terminal PT1 detects, based on a result of the CNN analysis, the line-of-sight position of the distributor TC indicated by a direction in which the line-of-sight of the distributor TC is facing (St6-3). A known technique other than the CNN analysis processing may be used for the processing of estimating the line-of-sight position.

On the other hand, when it is determined in the processing of step St5 that the face of the distributor TC cannot be detected from the captured image (St5, NO), the distributor terminal PT1 detects the switching of the slide of the shared material displayed in the shared material display region SC11 in the video distribution screen by the distributor TC operation (St11). Here, an example in which the shared material is a slide material formed by a plurality of pieces of image data for presentation is shown, but the shared material is not limited thereto, and may be, for example, a material in a portable document format (PDF). When the shared material is the material in the PDF format, the distributor terminal PT1 may detect switching of a page of the shared material.

The distributor terminal PT1 determines, based on the line-of-sight position of the distributor TC detected in the processing of step St6, whether the distributor TC is viewing the slide of the shared material displayed on the video distribution screen (that is, whether a detected line-of-sight position is positioned in the shared material display region SC11 displayed on the video distribution screen) (St7). When it is determined in the processing of step St7 that the distributor TC is viewing the slide of the shared material displayed on the video distribution screen (St7, YES), the distributor terminal PT1 proceeds to the processing of step St11, and performs detection of the switching of the slide of the shared material displayed in the shared material display region SC11 in the video distribution screen by the distributor TC operation (St11).

On the other hand, when it is determined in the processing of step St7 that the distributor TC is not viewing the slide of the shared material displayed on the video distribution screen (St7, NO), the distributor terminal PT1 determines whether the distributor TC is viewing any one of the viewer images displayed on the video distribution screen (that is, whether a detected line-of-sight position of the distributor TC is positioned in the viewer image display region SC12 on the video distribution screen) (St8).

When it is determined in the processing of step St8 that the distributor TC is viewing one of the viewer images displayed on the video distribution screen (St8, YES), the distributor terminal PT1 identifies, based on the detected line-of-sight position of the distributor TC, a viewer image viewed (gazed at) by the distributor TC and a viewer corresponding to the viewer image. When it is determined that the distributor TC is viewing one of the viewer images displayed on the video distribution screen, the distributor terminal PT1 further determines whether the line-of-sight of the distributor TC deviates from the viewer image. When it is determined that the line-of-sight of the distributor TC deviates from the viewer image (that is, the line-of-sight position of the distributor TC is positioned outside a region where the viewer image is displayed), the distributor terminal PT1 measures a time of a timing when the line-of-sight of the distributor TC deviates from the viewer image as the gaze time to the viewer corresponding to the viewer image, and records the time in the display order table (St9). Here, an example in which the gaze time is recorded in the display order table is described, but information recorded in the display order table may be information on the elapsed time from the gaze time to a current time.

When an operation of displaying a next slide of the shared material is performed by the distributor TC with reference to the display order table recorded in the memory 12, the distributor terminal PT1 updates the display order for determining the viewer image displayed in the viewer image display region SC12 of the video distribution screen in which the next slide is displayed in the shared material display region SC11 (St10).

When it is determined in the processing of step St8 that the distributor TC is not viewing any of the viewer images displayed on the video distribution screen (St8, NO), the distributor terminal PT1 proceeds to the processing of step St11, and performs detection of the switching of the slide of the shared material displayed in the shared material display region SC11 in the video distribution screen by the distributor TC operation (St11).

The distributor terminal PT1 determines whether the slide of the shared material displayed in the shared material display region SC11 in the video distribution screen is switched by the distributor TC operation (St12).

When it is determined in the processing of step St12 that the slide of the shared material displayed in the shared material display region SC11 in the video distribution screen is switched by the distributor TC operation (that is, switching is detected) (St12, YES), the distributor terminal PT1 proceeds to the processing of step St1, and determines whether there is the operation to end the online video distribution by the distributor TC (that is, whether the end operation is received by the input unit 14) (St1).

On the other hand, when it is determined in the processing of step St12 that the slide of the shared material displayed in the shared material display region SC11 in the video distribution screen is not switched by the distributor TC operation (that is, no switching is detected) (St12, NO), the distributor terminal PT1 moves to the processing of step St4, executes the image analysis on the captured image captured by the image capturing unit 13, and detects the face of the distributor TC (St4).

As described above, even when the online video distribution support system 100 according to the first embodiment cannot display the viewer images of all viewers on the first display unit 16A or the second display unit 16B, the online video distribution support system 100 can identify the viewer visually confirmed by the distributor TC based on a line-of-sight direction of the distributor TC. Further, the online video distribution support system 100 can determine, based on information of the identified viewer, the display order (priorities) for displaying the viewer images included in the video distribution screen, and can generate, using the determined display order (priorities), the video distribution screen in which the viewer images included in a current video distribution screen are switched to viewer images of viewers from the top to an M-th viewer in the display order (priorities). Therefore, since the online video distribution support system 100 can present, to the distributor TC, the video distribution screen including the viewer images of the viewers (that is, the viewers from the top to the M-th viewer in the display order (priorities)) to be visually confirmed by the distributor TC, the online video distribution support system 100 can generate the video distribution screen in which the viewer images of all the viewers who view the online video distribution can be visually confirmed evenly and more efficiently, and can support the visual confirmation of all the viewers by the distributor TC.

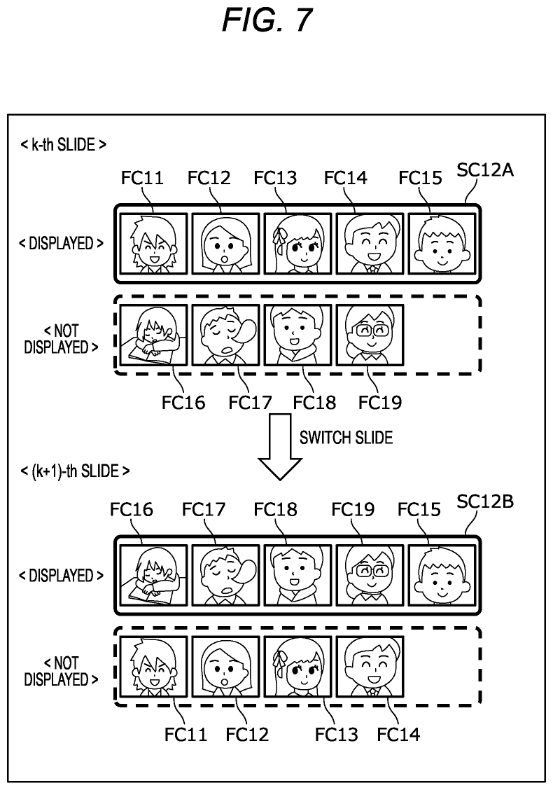

Here, referring to FIGS. 5 to 7, a procedure for switching the viewer image displayed in the viewer image display region SC12 of the video distribution screen shown in FIG. 2 will be described. FIG. 5 is a diagram showing an example of a display order table TB1 according to the first embodiment. FIG. 6 is a diagram showing an example of a display order table TB2 according to the first embodiment. FIG. 7 is a diagram showing an example of display switching of the viewer image according to the first embodiment.

In the examples shown in FIGS. 5 to 7, an example of switching the viewer image included in the video distribution screen based on the switching of the slide of the shared material will be described, but it is needless to say that the switching of the viewer image included in the video distribution screen may be executed every predetermined time set in advance.

In addition, in the display order table TB1 shown in FIG. 5 and the display order table TB2 shown in FIG. 6, an example is shown in which the elapsed time is recorded in units of minutes in order to facilitate understanding of the description, but it is needless to say that the elapsed time may be recorded in units of seconds, milliseconds, or the like. Further, the display order table TB1 shown in FIG. 5 is a display order table recorded in the memory 12 at a timing when the slide is switched to a k-th (k is an integer equal to or larger than 2) slide by the distributor TC operation in order to facilitate understanding of the description. Similarly, the display order table TB2 is a display order table recorded in the memory 12 at a timing when the slide is switched to a (k+1)-th slide by the distributor TC operation in order to facilitate understanding of the description.

In the display order table TB1 shown in FIG. 5 and the display order table TB2 shown in FIG. 6, an example is shown in which the identification information of the viewer and a face image of the viewer registered in advance are associated with each other in order to facilitate understanding of the description of switching the display of the viewer image on the video distribution screen at a time of switching from the k-th slide to the (k+1)-th slide shown in FIG. 7, but the face image of the viewer is not essential.

Each of the display order tables TB1 and TB2 is recorded (updated) by the determination unit 11B and recorded in the memory 12. In the display order table TB1, the identification information of the viewer (for example, a name of the viewer, a viewer number, a viewing number of the online video distribution, an Internet Protocol (IP) address of the viewer terminal, an e-mail address, and the like), the elapsed time, and the display order in association with each other are recorded for each viewer.

For example, the display order table TB1 shown in FIG. 5 records the elapsed time of each of nine viewers who view the online video distribution. For example, the display order table TB1 records (holds) following various kinds of data at a timing when the slide is switched to the k-th slide by the distributor TC operation. The name of the viewer shown in FIG. 5 is an example of the identification information of the viewer.

The viewer corresponding to a name “A” and a face image SCA has the elapsed time of “6 minutes” and the display order of “4”.

The viewer corresponding to a name “B” and a face image SCB has the elapsed time of “8 minutes” and the display order of “2”.

The viewer corresponding to a name “C” and a face image SCC has the elapsed time of “7 minutes” and the display order of “3”.

The viewer corresponding to a name “D” and a face image SCD has the elapsed time of “none” and the display order of “1”. The elapsed time “none” indicates that the distributor TC does not direct the line-of-sight toward the viewer at all. When the distributor TC does not direct the line-of-sight toward the viewer at all, the elapsed time recorded in the display order table TB1 may be an elapsed time from a start time of the online video distribution.

The viewer corresponding to a name “E” and a face image SCE has the elapsed time of “5 minutes” and the display order of “5”.

The viewer corresponding to a name “F” and a face image SCF has the elapsed time of “1 minute” and the display order of “9”.

The viewer corresponding to a name “G” and a face image SCG has the elapsed time of “2 minutes” and the display order of “8”.

The viewer corresponding to a name “H” and a face image SCH has the elapsed time of “4 minutes” and the display order of “6”.

The viewer corresponding to a name “I” and a face image SCI has the elapsed time of “3 minutes” and the display order of “7”.

The determination unit 11B rearranges the viewers in descending order of the elapsed time based on the display order table TB1 at the timing when the slide is switched to the k-th slide by the distributor TC operation, and determines the display order of all the viewers based on an order of the viewers after the rearrangement. The elapsed time of the viewer for which the elapsed time is not recorded is equal to an elapsed time from the start time of the online video distribution to the current time.

For example, the determination unit 11B determines, based on the display order table TB1 shown in FIG. 5, the display order of each of the nine viewers as the name “D”, the name “B”, the name “C”, the name “A”, the name “E”, the name “H”, the name “I”, the name “G”, and the name “F”. Here, an example in which the number of viewer images that can be displayed in the viewer image display region SC12 of the first display unit 16A is five will be described.

The determination unit 11B generates, based on the determined display order, the video distribution screen including a viewer image display region SC12A (see FIG. 7) including the viewer images of top five viewers in the determined display order (here, a viewer image FC11 with the name “D”, a viewer image FC12 with the name “B”, a viewer image FC13 with the name “C”, a viewer image FC14 with the name “A”, and a viewer image FC15 with the name “E”), and displays the video distribution screen on the first display unit 16A. Viewer images FC16, FC17, FC18, and FC19 of the four viewers corresponding to the name “H”, the name “I”, the name “G”, and the name “F” are not included in the viewer image display region SC12A, and are not displayed on the video distribution screen on which the k-th slide is displayed.

While the k-th slide is displayed in the shared material display region, the determination unit 11B continues to display the viewer image display region SC12A including the viewer image FC11 with the name “D”, the viewer image FC12 with the name “B”, the viewer image FC13 with the name “C”, the viewer image FC14 with the name “A”, and the viewer image FC15 with the name “E”, and updates the display order table TB1 based on the line-of-sight position of the distributor TC.

For example, the display order table TB2 shown in FIG. 6 is recorded in the memory 12 at a timing when the slide is switched to the (k+1)-th slide by the distributor TC operation. Here, an example in which the distributor TC switches the slide to the (k+1)-th slide three minutes after switching to the k-th slide will be described. The display order table TB2 records (holds) following various kinds of data at the timing when the slide is switched to the (k+1)-th slide by the distributor TC operation.

The viewer corresponding to the name “A” has the elapsed time of “1 minute” and the display order of “7”. The viewer corresponding to the name “B” has the elapsed time of “2 minutes” and the display order of “6”. The viewer corresponding to the name “C” has the elapsed time of “1 minute” and the display order of “8”. The viewer corresponding to the name “D” has the elapsed time of “1 minute” and the display order of “9”. The viewer corresponding to the name “E” has the elapsed time of “3 minutes” and the display order of “5”. The viewer corresponding to the name “F” has the elapsed time of “4 minutes” and the display order of “4”. The viewer corresponding to the name “G” has the elapsed time of “5 minutes” and the display order of “3”. The viewer corresponding to the name “H” has the elapsed time of “7 minutes” and the display order of “1”. The viewer corresponding to the name “I” has the elapsed time of “6 minutes” and the display order of “2”.

In an example shown in FIG. 6, an example is shown in which display orders of the viewers with the same elapsed time are determined to be different, but may be determined to be the same, and for example, the display orders of three viewers corresponding to the names “A”, “C”, and “D” may be determined to be “7”. In addition, the display orders of the viewers having the same elapsed time may be randomly determined, or may be determined in an order with early participation time of each viewer in the online video distribution. Further, the display orders of the viewers having the same elapsed time may be in an alphabetical order, a Japanese syllabic order, or the like of names of the viewers, or may be in an IP address order of the viewer terminals PS1 and so on.

The determination unit 11B rearranges the viewers in descending order of the elapsed time based on the display order table TB2 recorded in the memory 12 at the timing when the slide is switched to the (k+1)-th slide by the distributor TC operation, and determines the display order of all the viewers who view the online video distribution based on the order of the viewers after the rearrangement.

For example, the determination unit 11B determines, based on the display order table TB2 shown in FIG. 6, the display order (priorities) of each of the nine viewers as the name “H”, the name “I”, the name “G”, the name “F”, the name “E”, the name “B”, the name “A”, the name “C”, and the name “D”.

The determination unit 11B generates, based on the determined display order, the video distribution screen including a viewer image display region SC12B (see FIG. 7) including the viewer images of top five viewers in the determined display order (here, the viewer image FC16 with the name “H”, the viewer image FC17 with the name “I”, the viewer image FC18 with the name “G”, the viewer image FC19 with the name “F”, and the viewer image FC15 with the name “E”), and displays the video distribution screen on the first display unit 16A. The viewer images FC12, FC14, FC13, and FC11 of the four viewers corresponding to the name “B”, the name “A”, the name “C”, and the name “D” are not included in the viewer image display region SC12B, and are not displayed on the video distribution screen on which the (k+1)-th slide is displayed.

While the (k+1)-th slide is displayed in the shared material display region SC11, the determination unit 11B continues to display the viewer image display region SC12B including the viewer image FC16 with the name “H”, the viewer image FC17 with the name “I”, the viewer image FC18 with the name “G”, the viewer image FC19 with the name “F”, and the viewer image FC15 with the name “E”, and updates the display order table TB2 based on the line-of-sight position of the distributor TC.

Next, the video distribution screen displayed on the first display unit 16A of the distributor terminal PT1 will be described with reference to FIG. 8. FIG. 8 is a diagram showing an example of a use case of the distributor terminal PT1 and an example of the video distribution screen. FIG. 8 shows an example of the video distribution screen not including the shared material display region.

A display layout of the viewer image displayed in a viewer image display region SC13 shown in FIG. 8 is merely an example, and the present invention is not limited thereto. Although the distributor terminal PT1 in the example shown in FIG. 8 is a single display (that is, a configuration in which the distributor terminal PT1 includes only the first display unit 16A), the distributor terminal PT1 may be a dual display or a multi-display.

The first display unit 16A in the example of the use case shown in FIG. 8 displays the video distribution screen including the viewer image display region SC13.

In the viewer image display region SC13, viewer images FC31, FC32, FC33, FC34, FC35, FC36, FC37, FC38, and FC39 (live video) of the nine viewers are displayed based on the display order determined by the determination unit 11B in the processor 11. Specifically, the viewer image display region SC13 displays, based on the display order determined by the determination unit 11B in the processor 11, the viewer images FC38 and FC39 of the viewer having a high display order at a center of the viewer image display region SC13 and larger than the viewer images FC31 to FC37 of the other viewers. Each of the viewer images displayed in the viewer image display region SC13 is determined by the determination unit 11B at the timing when the input unit 14 receives an operation for requesting switching of the viewer image by the distributor TC.

A display method of the viewer image is not limited to the example described above. For example, based on the display order determined by the determination unit 11B in the processor 11, the distributor terminal PT1 may display the viewer image of the viewer having a high display order by superimposing a thick frame line on the viewer image, may display the viewer image of the viewer having a high display order in a size larger than a display size of the viewer image of the viewer having a low display order, or may change a background color of the viewer image of the viewer having a high display order to a predetermined color (for example, red, yellow, green, and the like) and display the viewer image.

As described above, in the online video distribution support system 100 according to the first embodiment, even when the viewer images of all the viewers who view the online video distribution in the viewer image display region SC12 can be displayed on the first display unit 16A or the second display unit 16B, the viewer image of the viewer having a high display order is emphasized and displayed based on the display order. Accordingly, the online video distribution support system 100 can present, to the distributor TC, the video distribution screen from which the viewers to be visually confirmed by the distributor TC are extracted (that is, viewers with high display orders), so that the online video distribution support system 100 can confirm the viewer images of all the viewers who view the online video distribution evenly and more efficiently, and can support confirmation of all the viewers by the distributor TC.

(Modification of First Embodiment)

The online video distribution support system 100 according to the first embodiment described above shows an example in which the distributor terminal PT1 determines the display order of the viewer. An online video distribution support system 100A according to the modification of the first embodiment describes an example in which a server S1, which is connected to the distributor terminal PT1 and a plurality of viewer terminals PS1 and so on to transmit and receive data to and from the distributor terminal PT1 and the plurality of viewer terminals PS1 and so on, determines the display order of the viewer.

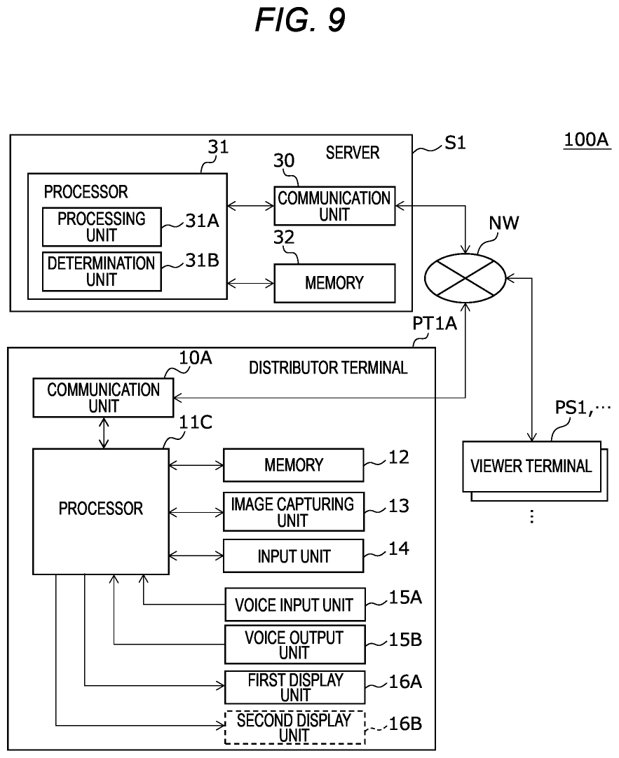

An internal configuration of the online video distribution support system 100A according to the modification of the first embodiment will be described with reference to FIG. 9. FIG. 9 is a block diagram showing an example of the internal configuration of the online video distribution support system 100A according to the modification of the first embodiment. As for the internal configuration of the online video distribution support system 100A according to the modification of the first embodiment shown in FIG. 9, similar configurations as those of the online video distribution support system 100 and the distributor terminal PT1 according to the first embodiment are denoted by the same reference signs, and the description thereof is omitted.

The online video distribution support system 100A according to the modification of the first embodiment executes functions executed by the processing unit 11A and the determination unit 11B in the distributor terminal PT1 according to the first embodiment by a processing unit 31A and a determination unit 31B of the server S1 in the modification of the first embodiment. Specifically, the server S1 in the modification of the first embodiment executes the operation procedure shown in FIGS. 3 and 4.

First, a distributor terminal PT1A according to the modification of the first embodiment will be described. The distributor terminal PT1A is connected to the server S1 and the plurality of viewer terminals PS1 and so on via the network NW so as to be able to perform wireless communication with the server S1 and the plurality of viewer terminals PS1 and so on. A processor 11C in the distributor terminal PT1A transmits the captured image captured by the image capturing unit 13 to the server S1. The processor 11C outputs the data of the shared material determined by the distributor TC to a communication unit 10A, or converts the distributor TC operation received by the input unit 14 into an electric signal, and outputs the electric signal to the communication unit 10A. The communication unit 10A transmits various kinds of data or signals output from the processor 11C to the server S1 via the network NW. In addition, the processor 11C outputs the video distribution screen transmitted from the server S1 to the first display unit 16A and the second display unit 16B and causes the first display unit 16A and the second display unit 16B to display the video distribution screen.

The server S1 according to the modification of the first embodiment is an example of the online video distribution support apparatus, and generates the video distribution screen displayed on the first display unit 16A and the second display unit 16B of the distributor terminal PT1A and a screen of the online video distribution displayed on the plurality of viewer terminals PS1 and so on. The server S1 includes a communication unit 30, a processor 31, and a memory 32.

The communication unit 30 transmits and receives data between the distributor terminal PT1A and the plurality of viewer terminals PS1 and so on via the network NW. The communication unit 30 outputs the captured image transmitted from the distributor terminal PT1A and the viewer image (live video) transmitted from the viewer terminals PS1 and so on to the processor 31. The communication unit 30 outputs the data of the shared material transmitted from the distributor terminal PT1A, the electric signal based on the distributor TC operation, and the like to the processor 31. In addition, the communication unit 30 transmits the video distribution screen generated by the determination unit 31B in the processor 31 to the distributor terminal PT1A.

The processor 31 is configured using, for example, the CPU or the FPGA, and performs various processing and control in cooperation with the memory 32. Specifically, the processor 31 refers to a program and data held in the memory 32, and executes the program to implement functions of each unit. The unit mentioned here is, for example, the processing unit 31A, the determination unit 31B, and the like.

The processing unit 31A executes a CNN analysis processing on the captured image transmitted from the distributor terminal PT1A, and estimates the line-of-sight position of the distributor TC. The processing unit 31A outputs the information on the line-of-sight position of the distributor TC, which is the estimation result, to the determination unit 31B. A known technique other than the CNN analysis processing may be used for the processing of estimating the line-of-sight position.

The determination unit 31B determines, based on the information of the line-of-sight position of the distributor TC output from the processing unit 31A, whether the distributor TC is viewing the shared material or any one of the viewer images. When it is determined that the line-of-sight position of the distributor TC is viewing one of the viewer images, the determination unit 31B further determines whether the line-of-sight position of the distributor TC deviates from the viewer corresponding to the viewer image. When it is determined that the line-of-sight position of the distributor TC deviates from the viewer image, the determination unit 31B acquires the time when the line-of-sight position of the distributor TC deviates from the viewer image as the gaze time when the distributor TC gazes at the viewer corresponding to the viewer image, outputs the elapsed time from the gaze time to the current time and the identification information that can identify the viewer in association with each other to the memory 32. The memory 32 updates the display order table based on the elapsed time output from the determination unit 31B and the identification information of the viewer.

In addition, the determination unit 31B determines, based on an electric signal transmitted from the distributor terminal PT1A, whether the shared material used for the online video distribution is switched by the distributor TC (for example, whether the page of the shared material is moved, the slide of the shared material is switched, or the like). When it is determined that the distributor TC switches the shared material, the determination unit 31B determines, based on the display order table, the display order of the viewer image displayed on the first display unit 16A or the second display unit 16B in the distributor terminal PT1A. The determination unit 31B generates, based on the determined display order of the viewer, the video distribution screen (see FIGS. 2 and 8) including the viewer image of the viewer displayed on the first display unit 16A or the second display unit 16B, transmits the video distribution screen to the distributor terminal PT1A, and causes the first display unit 16A or the second display unit 16B to display the video distribution screen.

When it is determined that the shared material is not switched for the predetermined time or more, the determination unit 31B may update the display order table (see FIGS. 5 and 6) recorded in the memory 32 at the timing when the predetermined time elapses.

The memory 32 includes a recording device including a semiconductor memory such as a RAM and a ROM and any one of storage devices such as an SSD and an HDD. The memory 32 records the identification information that can identify all the viewers who view the online video distribution, the display order table, and the like. The memory 32 stores the learning model used in the CNN analysis processing.

### Second Embodiment

The online video distribution support system 100 according to the first embodiment described above shows an example in which the display order of the viewer is determined based on the elapsed time elapsed since the distributor TC views the viewer. The online video distribution support system 100 according to the second embodiment describes an example in which, based on the elapsed time elapsed since the distributor TC views the viewer and a gaze continuation time in which the line-of-sight of the distributor TC continues to be directed toward the viewer (that is, continues to gaze), a score of gaze (hereinafter, referred to as a “gaze score”) by the distributor TC for each viewer (that is, the distributor TC directs the line-of-sight toward the viewer) is calculated, and the display order of the viewer is determined using a calculated gaze score.

Since the internal configuration of the online video distribution support system 100 according to the second embodiment has substantially similar configuration as that of the online video distribution support system 100 according to the first embodiment, different functions will be described in the following description.

When the determination unit 11B according to the second embodiment determines that, based on the line-of-sight position of the distributor TC, the distributor TC is viewing one of the viewer images displayed on the video distribution screen (that is, the line-of-sight position of the distributor TC is positioned within a display region of the viewer image), the determination unit 11B measures a time (hereinafter, “gaze continuation time”) from a time point when it is determined that the distributor TC starts viewing one of the viewer images displayed on the video distribution screen to a time point when it is determined that the distributor TC does not view the viewer image (that is, the line-of-sight position of the distributor TC is positioned outside the display region of the viewer image). In addition, the determination unit 11B measures the timing when it is determined that the line-of-sight position of the distributor TC is positioned outside the display region of the viewer image as the gaze time. In addition, the determination unit 11B calculates the elapsed time from the gaze time to the current time.

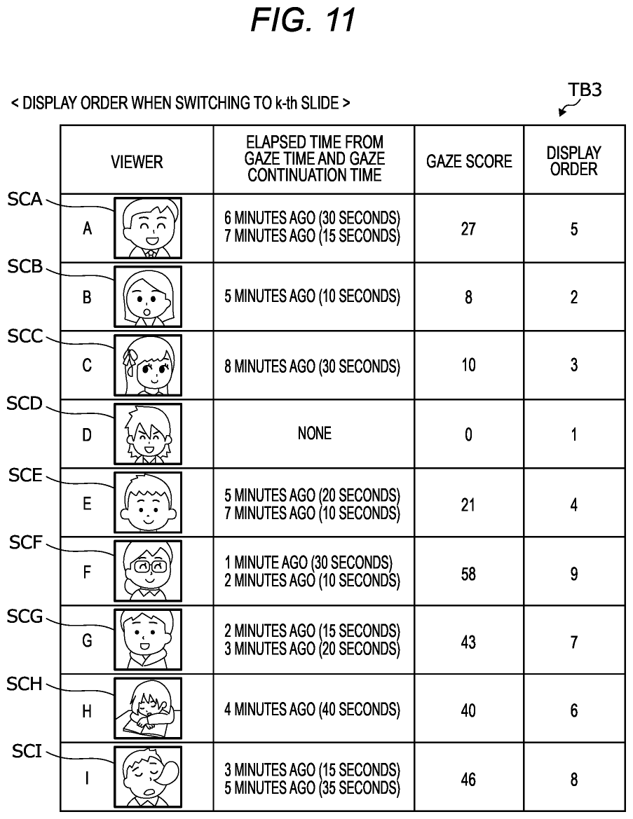

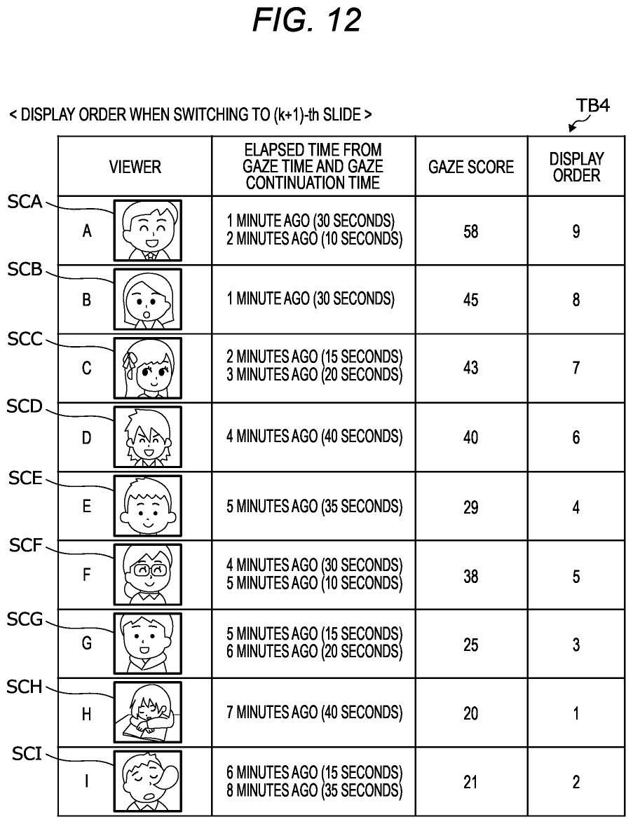

The determination unit 11B records a measured gaze continuation time Ar, elapsed time t, and the identification information of the viewer corresponding to the viewer image in association with each other in the display order table (see FIGS. 11 and 12) recorded in the memory 12. The display order table here is a table for calculating a gaze score S that the distributor TC gazes at each viewer. In the display order table, the gaze continuation time and the elapsed time measured from the current time to a predetermined time (for example, 10 minutes, 15 minutes, 20 minutes, and the like) are recorded for each viewer. The predetermined time for recording the gaze continuation time and the elapsed time is equal to a recording time T to be described later.

When the determination unit 11B detects the switching of the shared material displayed in the shared material display region on the video distribution screen by the distributor TC operation (that is, switching of the slide or the page of the shared material), the determination unit 11B refers to the display order table recorded in the memory 12 at a timing of detection, and calculates the gaze score S for each viewer. The gaze score S is a score indicating a degree of gaze of the distributor TC on the viewer, and becomes a higher value the more up-to-date the elapsed time t (that is, a time close to the current time), and the longer the gaze continuation time Δr. The determination unit 11B decreases the display order to be displayed on the first display unit 16A or the second display unit 16B for a viewer having a larger value of a calculated gaze score S, and increases the display order for a viewer having a smaller value of the gaze score S.

The gaze score S is calculated using a weighting function that attenuates with an increase in the elapsed time t that elapses since the distributor TC gazes at one of the viewers. In a calculation expression of the gaze score S in the second embodiment, an example in which a gain function (linear function) shown in Expression 1 is used as the weighting function will be described. The weighting function used for calculation of the gaze score S may be, for example, any linear function, cumulative distribution function, sigmoid function, or the like. The calculation expression of the gaze score S will be described below with reference to Expression 1 to Expression 3.

Expression 1 is the gain function as an example, and is a calculation expression of a coefficient to be attenuated in proportion to the elapsed time t that elapses from the gaze time by the distributor TC. That is, the coefficient calculated by Expression 1 decreases in proportion to the elapsed time t that elapses from the gaze time, and decreases a value of the gaze score S calculated using Expression 3. The elapsed time t shown in Expression 1 is the elapsed time from the gaze time to the current time. In addition, the recording time T shown in Expression 1 is a time for continuously recording (holding) line-of-sight data of the distributor TC (that is, the elapsed time t and the gaze continuation time) in the display order table for calculating the gaze score S.

The determination unit 11B starts measuring the elapsed time t from a timing when information of the elapsed time t and the gaze continuation time Δr is recorded in the display order table, and when it is determined that the elapsed time t is equal to or longer than the recording time T, deletes the information of the elapsed time and the gaze continuation time Ar in which the elapsed time t is equal to or longer than the recording time T. Here, as an example, a unit of the elapsed time t and the recording time T is minutes.

Expression 2 is a calculation expression of a ratio of the gaze continuation time Δr within one minute. The gaze continuation time Ar shown in Expression 2 is a time during which the detected line-of-sight position of the distributor TC is continuously detected in the display region of the viewer image (that is, a time during which the distributor TC continues to view one of the viewers). Here, as an example, a unit of the gaze continuation time Δr is seconds.

Expression 3 is a calculation expression for calculating the gaze score S of one viewer recorded from the recording time T (that is, the elapsed time t=T) to the current time (that is, the elapsed time t=0).

$$\begin{matrix}( Expression 1 ) & \\ gain ( t ) = 1 - \frac{t}{T} & ( 1 )\end{matrix}$$

$$\begin{matrix}( Expression 2 ) & \\ gaze ( t ) = \frac{Δ r}{60} & ( 2 )\end{matrix}$$

$$\begin{matrix}( Expression 3 ) & \\ S = 100 \times {\sum }_{t = 0}^{T} gain ( t ) \times gaze ( t ) & ( 3 )\end{matrix}$$

The determination unit 11B rearranges, based on a calculated gaze score S for each viewer, the viewers in ascending order of the gaze score S, and determines the order of the viewers after the rearrangement as the display order (priorities). The determination unit 11B determines, based on the determined display order, a predetermined number of viewers displayed in the viewer image display region of the first display unit 16A or the second display unit 16B. The determination unit 11B generates the video distribution screen including the viewer image corresponding to the determined predetermined number of viewers, outputs the video distribution screen to the first display unit 16A or the second display unit 16B, and causes the first display unit 16A or the second display unit 16B to display the video distribution screen.

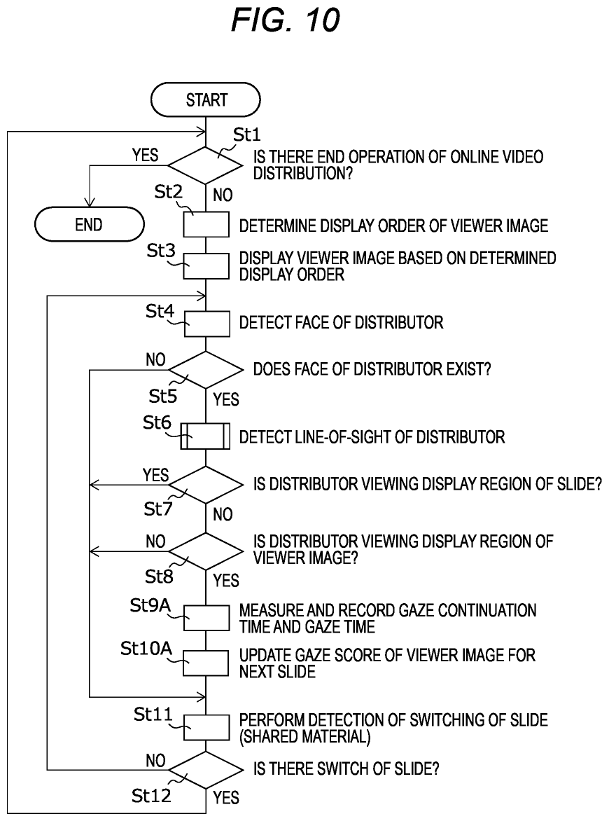

Next, an operation procedure of the distributor terminal PT1 according to the second embodiment will be described with reference to FIG. 10. FIG. 10 is a flowchart showing an example of the operation procedure of the distributor terminal PT1 according to the second embodiment. Since steps St1 to St8 and steps St11 and St12 in the example of the operation procedure of the distributor terminal PT1 shown in FIG. 10 are similar processing as the processing in the example of the operation procedure shown in FIG. 3, the same reference signs are denoted, and the description thereof is omitted.

In the example shown in FIG. 10, an example of switching the viewer image included in the video distribution screen based on the switching of the slide of the shared material is described, but it is needless to say that the switching of the viewer image included in the video distribution screen may be executed every predetermined time set in advance.

The distributor terminal PT1 determines whether the distributor TC is viewing any one of the viewer images displayed on the video distribution screen (that is, whether the detected line-of-sight position is positioned in the viewer image display region SC12 on the video distribution screen) (St8). When it is determined that the distributor TC is viewing one of the viewer images (St8, YES), the distributor terminal PT1 identifies, based on the detected line-of-sight position of the distributor TC, the viewer image viewed (gazed at) by the distributor TC. The distributor terminal PT1 measures the gaze continuation time Ar and the gaze time for the viewer corresponding to the identified viewer image (St9A).

The distributor terminal PT1 refers to the display order table recorded in the memory 12, calculates gaze scores of all the viewers recorded in the display order table, and updates the gaze scores. When an operation of displaying a next slide of the shared material is performed by the distributor TC, the distributor terminal PT1 updates the display order for determining the viewer image displayed in the viewer image display region SC12 on the video distribution screen in which the next slide is displayed in the shared material display region SC11 (St10A).

As described above, even when the viewer images of all the viewers cannot be displayed on the first display unit 16A or the second display unit 16B, the online video distribution support system 100 according to the second embodiment can determine, based on the time when the distributor TC visually confirms the viewer (that is, the gaze continuation time) and a frequency of the visual confirmation or the elapsed time since the visual confirmation, the display order (priorities) for displaying the viewer images included in the video distribution screen, and thus the display order (priorities) of the viewer images to be visually confirmed by the distributor TC can be determined more accurately. Therefore, since the online video distribution support system 100 can present, to the distributor TC, the video distribution screen including the viewer images of the viewers (that is, the viewers from the top to the M-th viewer in the display order (priorities)) to be visually confirmed by the distributor TC, the online video distribution support system 100 can generate the video distribution screen in which the viewer images of all the viewers who view the online video distribution can be visually confirmed evenly and more efficiently, and can support the visual confirmation of all the viewers by the distributor TC.

Here, referring to FIGS. 7, 11, and 12, a procedure for switching the viewer image displayed in the viewer image display region SC12 of the video distribution screen according to the second embodiment will be described. FIG. 11 is a diagram showing an example of a display order table TB3 according to the second embodiment. FIG. 12 is a diagram showing an example of a display order table TB4 according to the second embodiment.

In the examples shown in FIGS. 7, 11, and 12, an example of switching the viewer image included in the video distribution screen based on the switching of the slide of the shared material will be described, but it is needless to say that the switching of the viewer image included in the video distribution screen may be executed every predetermined time (for example, 5 minutes, 10 minutes, 15 minutes, and the like) set in advance.

In addition, in the display order table TB3 shown in FIG. 11 and the display order table TB4 shown in FIG. 12, an example is shown in which the elapsed time t from the gaze time for each viewer is recorded in units of minutes in order to facilitate understanding of the description, but it is needless to say that the elapsed time t may be recorded in units of seconds, milliseconds, or the like. The display order table TB3 is a display order table recorded in the memory 12 at a timing when the slide is switched to the k-th slide by the distributor TC operation in order to facilitate understanding of the description. The display order table TB4 is a display order table recorded in the memory 12 at a timing when the slide is switched to the (k+1)-th slide by the distributor TC operation in order to facilitate understanding of the description.

In the display order tables TB3 and TB4, an example is shown in which the identification information of the viewer and the face image of the viewer registered in advance are associated with each other in order to facilitate understanding of the description of switching the display of the viewer image on the video distribution screen at the time of switching from the k-th slide to the (k+1)-th slide shown in FIG. 12, but the face image of the viewer is not essential.

Each of the display order tables TB3 and TB4 is recorded in the memory 12 and recorded (updated) by the determination unit 11B. In addition, in each of the display order tables TB3 and TB4, when it is determined that the recorded elapsed time t exceeds the recording time T, information on the gaze continuation time in which the elapsed time t exceeds the recording time T is deleted by the determination unit 11B.

In the display order table TB3, the identification information of the viewer (for example, the name of the viewer, the viewer number, the viewing number of the online video distribution, the IP address of the viewer terminal, the e-mail address, and the like), the elapsed time, and the gaze continuation time in association with each other are recorded. The display order table TB3 shown in FIG. 11 shows an example in which the gaze score S is further associated and recorded in order to facilitate understanding of the example of the display switching of the viewer image of FIG. 12, which is not essential and may be omitted.

For example, the display order table TB3 shown in FIG. 11 records the elapsed time of each of nine viewers who view the online video distribution. For example, the display order table TB3 records (holds) the following various kinds of data at the timing when the slide is switched to the k-th slide by the distributor TC operation. The name of the viewer shown in FIG. 11 is an example of the identification information of the viewer.

The viewer corresponding to the name “A” and the face image SCA has the gaze continuation time of “30 seconds” for the elapsed time of “6 minutes”, the gaze continuation time of “15 seconds” for the elapsed time of “7 minutes”, and the gaze score S of “27”.

The viewer corresponding to the name “B” and the face image SCB has the gaze continuation time of “10 seconds” for the elapsed time of “5 minutes”, and the gaze score S of “8”.

The viewer corresponding to the name “C” and the face image SCC has the gaze continuation time of “30 seconds” for the elapsed time of “8 minutes”, and the gaze score S of “10”.

The viewer corresponding to the name “D and the face image SCD does not have the elapsed time and the gaze continuation time, and has the gaze score S of “0 (zero)”. That is, the line-of-sight of the distributor TC is not directed toward the viewer with the name “D” during the recording time T.

The viewer corresponding to the name “E” and the face image SCE has the gaze continuation time of “20 seconds” for the elapsed time of “5 minutes”, the gaze continuation time of “10 seconds” for the elapsed time of “7 minutes”, and the gaze score S of “21”.

The viewer corresponding to the name “F” and the face image SCF has the gaze continuation time of “30 seconds” for the elapsed time of “1 minute”, the gaze continuation time of “10 seconds” for the elapsed time of “2 minutes”, and the gaze score S of “58”.

The viewer corresponding to the name “G” and the face image SCG has the gaze continuation time of “15 seconds” for the elapsed time of “2 minutes”, the gaze continuation time of “20 seconds” for the elapsed time of “3 minutes”, and the gaze score S of “43”.

The viewer corresponding to the name “H” and the face image SCH has the gaze continuation time of “40 seconds” for the elapsed time of “4 minutes”, and the gaze score S of “40”.

The viewer corresponding to the name “I” and the face image SCI has the gaze continuation time of “15 seconds” for the elapsed time of “3 minutes”, the gaze continuation time of “35 seconds” for the elapsed time of “5 minutes”, and the gaze score S of “46”.

The determination unit 11B calculates the gaze score S of each of the nine viewers described above at the timing when the slide is switched to the k-th slide by the distributor TC operation, and rearranges, based on a calculated gaze score S for each viewer, the viewers in ascending order of the gaze score S. The determination unit 11B determines, based on the order of the viewers after the rearrangement, the display order (priorities) of all the viewers. Specifically, the determination unit 11B determines the display order of the viewer having the smallest gaze score S as the highest order.

For example, the determination unit 11B determines, based on the display order table TB3 shown in FIG. 11, the display order (priorities) of each of the nine viewers as the name “D”, the name “B”, the name “C”, the name “E”, the name “A”, the name “H”, the name “G”, the name “I”, and the name “F”. Here, an example in which the number of viewer images that can be displayed in the viewer image display region SC12 of the first display unit 16A is five will be described.

The determination unit 11B generates, based on the determined display order, the video distribution screen including the viewer image display region SC12A (see FIG. 7) including the viewer images of top five viewers in the determined display order (here, the viewer image FC11 with the name “D”, the viewer image FC12 with the name “B”, the viewer image FC13 with the name “C”, the viewer image FC14 with the name “A”, and the viewer image FC15 with the name “E”), and displays the video distribution screen on the first display unit 16A. The viewer images FC16, FC17, FC18, and FC19 of the four viewers corresponding to the name “H”, the name “I”, the name “G”, and the name “F” are not included in the viewer image display region SC12A (see FIG. 7), and are not displayed on the video distribution screen on which the (k+1)-th slide is displayed.

While the k-th slide is displayed in the shared material display region SC11, the determination unit 11B continues to display the viewer image display region SC12A including the viewer image FC11 with the name “D”, the viewer image FC12 with the name “B”, the viewer image FC13 with the name “C”, the viewer image FC14 with the name “A”, and the viewer image FC15 with the name “E”, and updates the display order table TB3 based on the line-of-sight position of the distributor TC.

For example, the display order table TB4 shown in FIG. 12 is recorded in the memory 12 at the timing when the slide is switched to the (k+1)-th slide by the distributor TC operation. Here, an example in which the distributor TC switches the slide to the (k+1)-th slide three minutes after switching to the k-th slide will be described. The display order table TB3 records (holds) following various kinds of data at the timing when the slide is switched to the k-th slide by the distributor TC operation. The name of the viewer shown in FIG. 12 is an example of the identification information of the viewer.

The viewer corresponding to the name “A” and the face image SCA has the gaze continuation time of “30 seconds” for the elapsed time of “1 minute”, the gaze continuation time of “10 seconds” for the elapsed time of “2 minutes”, and the gaze score S of “58”.

The viewer corresponding to the name “B” and the face image SCB has the gaze continuation time of “30 seconds” for the elapsed time of “1 minute”, and the gaze score S of “45”.

The viewer corresponding to the name “C” and the face image SCC has the gaze continuation time of “15 seconds” for the elapsed time of “2 minutes”, the gaze continuation time of “20 seconds” for the elapsed time of “3 minutes”, and the gaze score S of “43”.

The viewer corresponding to the name “D” and the face image SCD has the gaze continuation time of “40 seconds” for the elapsed time of “4 minutes”, and the gaze score S of “40”.

The viewer corresponding to the name “E” and the face image SCE has the gaze continuation time of “35 seconds” for the elapsed time of “5 minutes”, and the gaze score S of “29”.

The viewer corresponding to the name “F” and the face image SCF has the gaze continuation time of “30 seconds” for the elapsed time of “4 minutes”, the gaze continuation time of “10 seconds” for the elapsed time of “5 minutes”, and the gaze score S of “38”.

The viewer corresponding to the name “G” and the face image SCG has the gaze continuation time of “15 seconds” for the elapsed time of “5 minutes”, the gaze continuation time of “20 seconds” for the elapsed time of “6 minutes”, and the gaze score S of “25”.

The viewer corresponding to the name “H” and the face image SCH has the gaze continuation time of “40 seconds” for the elapsed time of “7 minutes”, and the gaze score S of “20”.

The viewer corresponding to the name “I” and the face image SCI has the gaze continuation time of “15 seconds” for the elapsed time of “6 minutes”, the gaze continuation time of “35 seconds” for the elapsed time of “8 minutes”, and the gaze score S of “21”.

The determination unit 11B calculates the gaze score S of each of the nine viewers described above at the timing when the slide is switched to the k-th slide by the distributor TC operation, and determines, based on the calculated gaze score S for each viewer, the display order (priorities) of all the viewers.

For example, the determination unit 11B determines, based on the display order table TB4 shown in FIG. 12, the display order (priorities) of each of the nine viewers as the name “H”, the name “I”, the name “G”, the name “E”, the name “F”, the name “D”, the name “C”, the name “B”, and the name “A”. The determination unit 11B generates, based on the determined display order, the video distribution screen including the viewer image display region SC12B (see FIG. 7) including the viewer images of top five viewers in the determined display order (here, the viewer image FC16 with the name “H”, the viewer image FC17 with the name “I”, the viewer image FC18 with the name “G”, the viewer image FC15 with the name “E”, and the viewer image FC19 with the name “F”), and displays the video distribution screen on the first display unit 16A. The viewer images FC11, FC13, FC12, and FC14 of the four viewers corresponding to the name “D”, the name “C”, the name “B”, and the name “A” are not included in the viewer image display region SC12B (see FIG. 7), and are not displayed on the video distribution screen on which the (k+1)-th slide is displayed.

While the (k+1)-th slide is displayed in the shared material display region, the determination unit 11B continues to display the viewer image display region SC12B including the viewer image FC16 with the name “H”, the viewer image FC17 with the name “I”, the viewer image FC18 with the name “G”, the viewer image FC15 with the name “E”, and the viewer image FC19 with the name “F”, and updates the display order table TB4 based on the line-of-sight position of the distributor TC.

As described above, the online video distribution support system 100, 100A according to the first embodiment, the modification of the first embodiment, and the second embodiment is performed by a system including one or more computers (for example, the distributor terminal PT1, the server S1) that are connected to communicate with a plurality of viewer terminals PS1 and so on used by N (N being an integer equal to or larger than 3) viewers, respectively, who view the online video distribution, and acquires the viewer image from each of the viewer terminal PS1 and so on, the viewer image being obtained by capturing an image of the viewer; displays the video distribution screen (see FIGS. 2 and 8) (an example of the screen) including the viewer images obtained by capturing images of M (M being an integer equal to or larger than 2 and M≤N) viewers, respectively; detects, using the captured image obtained by capturing an image of the distributor TC who performs the online video distribution, the line-of-sight direction of the distributor; determines, based on the line-of-sight direction, the viewer corresponding to the viewer image on the video distribution screen toward which the line-of-sight of the distributor is directed, and determines the display order (priorities) of the viewer images to be displayed on the video distribution screen; and generates an updated video distribution screen using the determined display order (priorities) to switch the viewer images on the video distribution screen, and displays the updated video distribution screen. The online video distribution support system 100, 100A may be configured to include the computer of either the distributor terminal PT1 or the server S1, or may be configured to include the respective computers of the distributor terminal PT1 and the server S1.

Accordingly, even when the online video distribution support system 100, 100A according to the first embodiment, the modification of the first embodiment, and the second embodiment cannot display the viewer images of all the viewers on the first display unit 16A or the second display unit 16B, the online video distribution support system 100, 100A can identify, based on the line-of-sight direction of the distributor TC, the viewer visually confirmed by the distributor TC. Further, the online video distribution support system 100, 100A can determine, based on the information of the identified viewer, the display order (priorities) for displaying the viewer images included in the video distribution screen, and can generate, using the determined display order (priorities), the video distribution screen in which the viewer images included in the current video distribution screen are switched to the viewer images of the viewers from the top to the M-th viewer in the display order (priorities). Therefore, since the online video distribution support system 100, 100A can present, to the distributor TC, the video distribution screen including the viewer images of the viewers (that is, the viewers from the top to the M-th viewer in the display order (priorities)) to be visually confirmed by the distributor TC, the online video distribution support system 100, 100A can generate the video distribution screen in which the viewer images of all the viewers who view the online video distribution can be visually confirmed evenly and more efficiently, and can support the visual confirmation of all the viewers by the distributor TC.

As described above, the online video distribution support system 100, 100A according to the first embodiment and the modification of the first embodiment records the gaze time (an example of a time point indicated in information contained in time information) for each of the viewers based on the line-of-sight direction, the gaze time (an example of time information) at which the line-of-sight of the distributor deviates from the viewer image on the video distribution screen toward which the line-of-sight of the distributor TC has been directed, and determines the display order (priorities) based on the gaze time. Accordingly, since the online video distribution support system 100, 100A according to the first embodiment and the modification of the first embodiment can determine, based on the gaze time, the display order (priorities) of the viewers to be visually confirmed by the distributor TC, the online video distribution support system 100, 100A can generate the video distribution screen on which the viewer images of all the viewers who view the online video distribution can be visually confirmed evenly and more efficiently.

As described above, the online video distribution support system 100, 100A according to the first embodiment and the modification of the first embodiment rearranges the N viewers in descending order of the elapsed time from the gaze time to the current time, and determines the order of the N viewers after rearrangement as the display order (priorities). Accordingly, since the online video distribution support system 100, 100A according to the first embodiment and the modification of the first embodiment can determine, based on the gaze time, the display order (priorities) of the viewers to be visually confirmed by the distributor TC, the online video distribution support system 100, 100A can generate the video distribution screen on which the viewer images of all the viewers who view the online video distribution can be visually confirmed evenly and more efficiently.

As described above, the online video distribution support system 100, 100A according to the modification of the first embodiment and the second embodiment records the gaze continuation time (an example of duration information) and the gaze time for each of the viewers based on the line-of-sight direction, the gaze continuation time in which the distributor TC continues to be directed toward the viewer image on the video distribution screen, the gaze time at which the line-of-sight of the distributor deviates from the viewer image on the video distribution screen, and determines the display order (priorities) based on the gaze continuation time and the gaze time recorded for each viewer. Accordingly, the online video distribution support system 100, 100A according to the modification of the first embodiment and the second embodiment can determine, based on the time when the distributor TC visually confirms the viewer (that is, the gaze continuation time) and the frequency of the visual confirmation or the elapsed time since the visual confirmation, the display order (priorities) for displaying the viewer images included in the video distribution screen, and thus the display order (priorities) of the viewer images to be visually confirmed by the distributor TC can be determined more accurately. Therefore, since the online video distribution support system 100, 100A can present, to the distributor TC, the video distribution screen including the viewer images of the viewers (that is, the viewers from the top to the M-th viewer in the display order (priorities)) to be visually confirmed by the distributor TC, the online video distribution support system 100, 100A can generate the video distribution screen in which the viewer images of all the viewers who view the online video distribution can be visually confirmed evenly and more efficiently.

As described above, the online video distribution support system 100, 100A according to the modification of the first embodiment and the second embodiment calculates the elapsed time t that elapses from the gaze time to the current time, calculates a gaze score S (an example of the score) for each viewer based on the function (specifically, the function indicated by (Expression 1)) that decreases the display order (priorities) with an increase in the elapsed time t, the gaze time, and the gaze continuation time, the gaze score S (an example of the score) indicating a degree of gaze of the distributor TC on the viewer corresponding to the viewer image on the video distribution screen, and determines the display order (priorities) based on the gaze score S. Accordingly, in the online video distribution support system 100, 100A according to the modification of the first embodiment and the second embodiment, since the gaze score S for determining the display order (priorities) is small based on the elapsed time t since the visual confirmation, the display order (priorities) of the viewer images to be visually confirmed by the distributor TC can be determined more accurately. Therefore, since the online video distribution support system 100, 100A can present, to the distributor TC, the video distribution screen including the viewer images of the viewers (that is, the viewers from the top to the M-th viewer in the display order (priorities)) to be visually confirmed by the distributor TC, the online video distribution support system 100, 100A can generate the video distribution screen in which the viewer images of all the viewers who view the online video distribution can be visually confirmed evenly and more efficiently.

As described above, the gaze score S calculated by the online video distribution support system 100, 100A according to the modification of the first embodiment and the second embodiment is calculated by using all of the gaze continuation times and all of the gaze times recorded, for each viewer, during a past prescribed time period from the current time. The prescribed time period is an example of the recording time T. Accordingly, the online video distribution support system 100, 100A according to the modification of the first embodiment and the second embodiment can calculate the gaze score S by using all the gaze continuation times and the gaze times recorded for each viewer from the recording time T (that is, the elapsed time t=T) to the current time (that is, the elapsed time t=0). Therefore, the online video distribution support system 100, 100A can generate the video distribution screen in which the viewer images of all the viewers who view the online video distribution can be visually confirmed evenly and more efficiently.

As described above, the online video distribution support system 100, 100A according to the modification of the first embodiment and the second embodiment rearranges the N viewers in ascending order of the gaze score S, and determines the order of the N viewers after the rearrangement as the display order (priorities). Accordingly, since the online video distribution support system 100, 100A according to the modification of the first embodiment and the second embodiment can determine, based on the gaze score S, the display order (priorities) of the viewer to be visually confirmed by the distributor TC, the online video distribution support system 100, 100A can generate the video distribution screen on which the viewer images of all the viewers who view the online video distribution can be visually confirmed evenly and more efficiently.

As described above, the online video distribution support system 100, 100A according to the modification of the first embodiment and the second embodiment determine the display order (priorities) in a case in which it is determined that the shared material displayed on the video distribution screen is switched by the distributor TC (for example, switching of the slide of the shared material, switching of the page, and the like). Accordingly, the online video distribution support system 100, 100A according to the modification of the first embodiment and the second embodiment can control a timing of switching the viewer image included in the video distribution screen by the distributor TC, and can implement presentation of the video distribution screen in which the viewer images of all the viewers who view the online video distribution can be visually confirmed evenly and more efficiently.

As described above, the online video distribution support system 100, 100A according to the modification of the first embodiment and the second embodiment determines the priorities at prescribed time intervals (for example, 5 minutes, 10 minutes, 15 minutes, or the like). Accordingly, the online video distribution support system 100, 100A according to the modification of the first embodiment and the second embodiment can execute the switching of the viewer image included in the video distribution screen at prescribed time intervals (for example, 5 minutes, 10 minutes, 15 minutes, or the like), and can implement the presentation of the video distribution screen in which the viewer images of all the viewers who view the online video distribution can be visually confirmed evenly and more efficiently.

As described above, the distributor terminal PT1 according to the first embodiment and the second embodiment and the server S1 according to the modification of the first embodiment include one or more computers (for example, the distributor terminal PT1, the server S1), and include: an acquisition unit (the communication unit 10 in the distributor terminal PT1, the communication unit 30 in the server S1) configured to acquire a viewer image of each of N (N being an integer equal to or larger than 3) viewers who views the online video distribution; an output unit (the first display unit 16A or second display unit 16B in the distributor terminal PT1, the communication unit 30 in the server S1) configured to output the video distribution screen (see FIGS. 2 and 8) including the viewer images obtained by capturing images of M (M being an integer equal to or larger than 2 and M≤N) viewers; a detection unit (the processing unit 11A in the distributor terminal PT1, the processing unit 31A in the server S1) configured to detect, using the captured image obtained by capturing an image of the distributor who performs the online video distribution, the line-of-sight direction of the distributor; and a control unit (the determination unit 11B in the distributor terminal PT1, the determination unit 31B in the server S1) configured to determine, based on the line-of-sight direction, the viewer corresponding to the viewer image on the video distribution screen toward which the line-of-sight of the distributor is directed, and determine the display order (priorities) of the viewer images to be displayed on the video distribution screen, generate an updated video distribution screen using the determined priorities to switch the viewer images on the video distribution screen, and output the updated video distribution screen to the output unit.

Accordingly, even when the distributor terminal PT1 according to the first embodiment and the second embodiment and the server S1 according to the modification of the first embodiment cannot display the viewer images of all the viewers on the first display unit 16A or the second display unit 16B, the distributor terminal PT1 and the server S1 can identify, based on the line-of-sight direction of the distributor TC, the viewer visually confirmed by the distributor TC. Further, the distributor terminal PT1 and the server S1 can determine, based on the information of the identified viewer, the display order (priorities) for displaying the viewer images included in the video distribution screen, and can generate, using the determined display order (priorities), the video distribution screen in which the viewer images included in the current video distribution screen are switched to the viewer images of the viewers from the top to the M-th viewer in the display order (priorities). Therefore, since the distributor terminal PT1 and the server S1 can present, to the distributor TC, the video distribution screen including the viewer images of the viewers (that is, the viewers from the top to the M-th viewer in the display order (priorities)) to be visually confirmed by the distributor TC, the distributor terminal PT1 and the server S1 can generate the video distribution screen in which the viewer images of all the viewers who view the online video distribution can be visually confirmed evenly and more efficiently, and can support the visual confirmation of all the viewers by the distributor TC.

Although various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in various embodiments described above may be combined freely in a range without deviating from the spirit of the invention.

The present disclosure is useful as an online video distribution support method and an online video distribution support apparatus that more effectively display a gallery view of viewers who view online video distribution and efficiently support visual confirmation of a state of a viewer by a distributor.

1. An online video distribution support method performed by a system comprising one or more computers that are connected to communicate with a plurality of viewer terminals used by N (N being an integer equal to or larger than 3) viewers, respectively, who view online video distribution, the online video distribution support method comprising:
acquiring a viewer image from each of the viewer terminals, the viewer image being obtained by capturing each of the viewers;
displaying a screen including viewer images obtained by capturing images of M (M being an integer equal to or larger than 2 and M≤N) viewers, respectively;
detecting, using a captured image obtained by capturing an image of a distributor who performs the online video distribution, a line-of-sight direction of the distributor;
determining, based on the line-of-sight direction, a viewer corresponding to a viewer image on the screen toward which a line-of-sight of the distributor is directed, and determining priorities of the viewer images to be displayed on the screen; and
generating an updated screen using the priorities to switch the viewer images on the screen, and displaying the updated screen.

2. The online video distribution support method according to claim 1, comprising:
recording time information for each of the viewers based on the line-of-sight direction, the time information containing information indicating a time point at which the line-of-sight of the distributor deviates from a viewer image on the screen toward which the line-of-sight of the distributor has been directed,
determining the priorities based on the time information.

3. The online video distribution support method according to claim 2, comprising:
rearranging the N viewers in descending order of an elapsed time from the time point indicated in the time information to a current time; and
determining an order of the N viewers after rearrangement as the priorities.

4. The online video distribution support method according to claim 1, comprising:
recording duration information and time information for each of the viewers based on the line-of-sight direction, the duration information containing information indicating a continuation time in which the line-of-sight of the distributor continues to be directed toward a viewer image on the screen, the time information containing information indicating a time point at which the line-of-sight of the distributor deviates from the viewer image on the screen; and
determining the priorities based on the duration information and the time information recorded for each of the viewers.

5. The online video distribution support method according to claim 4, comprising:
calculating an elapsed time from the time point indicated in the time information to the current time;
calculating a score for each of the viewers based on a function that decreases the priorities with an increase in the elapsed time, the time information, and the duration information, the score indicating a degree of gaze of the distributor on each of the viewers corresponding to the viewer image on the screen; and
determining the priorities based on the score.

6. The online video distribution support method according to claim 5, comprising:
calculating the score using all of the duration information and all of the time information recorded, for each of the viewers, during a past prescribed time period from the current time.

7. The online video distribution support method according to claim 5, comprising:
rearranging the N viewers in ascending order of the score, and determining the order of the N viewers after rearrangement as the priorities.

8. The online video distribution support method according to claim 1, comprising:
determining the priorities in a case in which it is determined that a shared material displayed on the screen is switched by the distributor.

9. The online video distribution support method according to claim 1, comprising:
determining the priorities at prescribed time intervals.

10. An online video distribution support apparatus comprising one or more computers, the online video distribution support apparatus comprising:
an acquisition unit configured to acquire a viewer image of each of N (N being an integer equal to or larger than 3) viewers who views online video distribution;
an output unit configured to output a screen including viewer images obtained by capturing images of M (M being an integer equal to or larger than 2 and M≤N) viewers;
a detection unit configured to detect, using a captured image obtained by capturing an image of a distributor who performs the online video distribution, a line-of-sight direction of the distributor; and
a control unit configured to:
determine, based on the line-of-sight direction, a viewer corresponding to a viewer image on the screen toward which a line-of-sight of the distributor is directed, and determine priorities of the viewer images to be displayed on the screen;
generate an updated screen using the priorities to switch the viewer images on the screen, and output the updated screen to the output unit.
